(19) United States
(12) Patent Application Publication
(10) Pub. No.: US 2024/0128734 A1
(43) Pub. Date: Apr. 18, 2024

(54) ELECTRIC VEHICLE CHARGING SYSTEM

(71) Applicant: EVeraTechnologies Inc., Montréal (CA)

(72) Inventor: Karl-Olivier THERRIEN, Montréal (CA)

(73) Assignee: EVeraTechnologies Inc., Montréal (CA)

(21) Appl. No.: 18/488,766

(22) Filed: Oct. 17, 2023

Related U.S. Application Data
(60) Provisional application No. 63/417,030, filed on Oct. 18, 2022.

(51) Int. Cl. H02G 11/00; B60L 53/31

(52) U.S. Cl. CPC H02G 11/003; B60L 53/31

(57) ABSTRACT

A cable management system for an electric charging station for an electric vehicle and a method for managing a cable of a charging station are provided. The cable management system comprises a braking device located at a cable outlet of the electric charging station, the braking device having a free pulling zone having free pulling bristles and a braking zone having braking bristles, the braking bristles being stiffer than the free pulling bristles and the braking bristles being configured to at least partially immobilize a charging cable outside of the cable outlet of the electric charging station by applying friction to the charging cable to brake any movement of the cable into the charging station during charging of the electric vehicle, the friction applied to the charging cable by the braking bristles being higher than by the free pulling bristles.

### RELATED APPLICATION

The present application claims priority to or benefit of U.S. provisional patent application No. 63/417,030, filed Oct. 18, 2022, which is incorporated herein by reference in its entirety.

### TECHNICAL FIELD

The present disclosure relates generally to charging of electric vehicles (EVs) and, more particularly, to systems and methods for electric charging stations.

### BACKGROUND

EVs and charging stations for EVs have become very popular. EV chargers are installed on sidewalks along the pavement in order to be near the vehicles requiring charging. In one type of configuration, two chargers are grouped together and placed between two EV parking places in order to connect both from that location. This results into a considerably big unit fitted with long cables to reach the EV charging socket which can be located anywhere around the EV.

The chargers require an electrical entrance, breakers and power meters to be in compliance with the applicable electrical code. The result is normally a bulky installation surrounded by several twisted wires, at the same time using critical space on the sidewalk and being very vulnerable to impacts from vehicles on the street and snow removal equipment on the sidewalk.

The charging cables need to be long enough and manageable for charging the EVs, while they also need to be stored securely between the charging sessions. FIGS. 1A and 1B illustrate a conventional hook known in the prior art and usually used by a conventional charging cable during the charging session. FIG. 1B illustrates a conventional (known in the prior art) storage of the charging cable. Due to such storage, the cable excessively bends, as illustrated in FIG. 1B, and therefore the cable may deteriorate, especially in the area next to a charging plug.

Another problem associated with conventional EV charging stations is the tension and jerking that the cable applies onto the vehicle's plug receiver. It is often the case that the driver parks the EV away and/or applies high tension onto the cable in order to reach the EV's plug receiver to insert the plug therein. This tension, coupled with wind or other factors, often results in damaging the EV's plug receiver over time.

### SUMMARY

According to one aspect of the disclosed technology, there is provided a cable management system for an electric charging station for an electric vehicle, the cable management system comprising: a braking device located at a cable outlet of the electric charging station, the braking device having a free pulling zone having free pulling bristles and a braking zone having braking bristles, the braking bristles being stiffer than the free pulling bristles and the braking bristles being configured to at least partially immobilize a charging cable outside of the cable outlet of the electric charging station by applying friction to the charging cable to brake any movement of the cable into the charging station during charging of the electric vehicle, the friction applied to the charging cable by the braking bristles being higher than by the free pulling bristles.

The cable management system may further comprise a pair of braking blocks having a braking gap therebetween and located in the braking zone of the braking device for immobilization of the charging cable when the charging cable is placed into the braking zone by moving the charging cable out from the free pulling zone. The braking bristles may be stiffer than the free pulling bristles to be able to hold the cable in place and outweigh a portion of the cable and a plug that extends outside the electric charging station. In at least one embodiment, the diameter of the braking bristles is larger than the diameter of the free pulling bristles. The free pulling bristles may be curled. In at least one embodiment, the braking bristles and the free pulling bristles are attached to bristle holders.

The cable management system may further comprise: a mobile pulley system and a fixed pulley system, each comprising a plurality of cable wheels located on arcs along which the charging cable moves when the charging cable is extended out of the charging station by a pulling force applied by a user to the charging cable and when the charging cable is retracted into the charging station by a force of gravity on a weight object of the mobile pulley system which simultaneously displaces towards a lowered position, the mobile pulley system being located lower than the fixed pulley system and being configured to travel up and down along ledges of the charging station. The mobile pulley system may comprise rollers, each roller having a groove configured to receive a portion of one ledge to allow the mobile pulley system to slide up and down the ledges. The groove of each roller may have a tapered inner surface.

The cable management system may have an anchor and a plug holder configured to receive the anchor. The anchor may have a tunnel for receiving a portion of the charging cable therein and a slit which defines two edges of the anchor that permit the anchor to be clamped onto the charging cable and grip the cable immovably when a distance between the two edges is reduced when the anchor is fit into an anchor groove located in the plug holder.

The cable management system may have a lock configured to lock the mobile pulley system in a locking position. The cable management system may further comprise an additional mechanical cable braking system configured to pinch the cable to prevent the cable from retracting back into the charging system. The additional mechanical cable braking system may be located inside the charging system and behind the braking blocks. The additional mechanical cable braking system may be operated by a motor.

According to another aspect of the disclosed technology, there is provided a cable management system comprising: a mobile pulley system and a fixed pulley system, each comprising a plurality of cable wheels located on arcs along which the charging cable moves when the charging cable is extended out of the charging station by a pulling force applied by a user to the charging cable and when the charging cable is retracted into the charging station by a force of gravity on a weight object of the mobile pulley system which simultaneously displaces towards a lowered position, the mobile pulley system being located lower than the fixed pulley system and being configured to travel up and down along ledges (also referred to herein as “rails”) of the charging station.

The mobile pulley system may comprise rollers, each roller having a groove configured to receive a portion of one ledge to allow the mobile pulley system to slide up and down the ledges. The groove of each roller may have a tapered inner surface. The cable management system may have an anchor and a complementary plug holder. The cable management system may have a lock configured to lock the mobile pulley system to restrict movement of the mobile pulley system. The cable management system may further comprise an additional mechanical cable braking system configured to pinch the cable to prevent the cable from retracting back into the charging system.

According to another aspect of the disclosed technology, there is provided a method for managing a cable of a charging station, the method comprising: in response to receiving a first indication from a processor, the first indication being generated when a magnet located on an anchor is detected by a magnet detector located on a plug holder, locking a lock restricting movement of a mobile pulley system; in response to receiving a second indication from the processor, unlocking the lock restricting movement of the mobile pulley system to allow the cable to be extended outside of the charging station; and after the mobile pulley system has moved, in response to receiving a third indication from the processor, activating an additional mechanical cable braking system to restrict movement of the cable while the cable is in an extended position, the indication from the processor being activated in response to the plug being connected to an electric vehicle.

According to another aspect of the disclosed technology, there is provided a system for managing a cable of a charging station, the system comprising: a lock configured to restrict movement of a mobile pulley system and to be unlocked to allow the cable to be extended from the charging station; and a magnet located on an anchor, the anchor being attached to the cable, the magnet configured to be detected by a magnet detector located on a plug holder of the charging station. In at least one embodiment, a system for managing a cable of a charging station comprises: a magnet located on an anchor, the anchor being attached to the cable, the magnet configured to be detected by a magnet detector located on a plug holder of the charging station; and a lock configured: to restrict movement of a mobile pulley system in response to receiving a first indication that the magnet is detected by a magnet detector located on a plug holder, and to be unlocked in response to receiving a second indication to allow the cable to be extended from the charging station. The system may further comprise an additional mechanical cable braking system configured to restrict movement of the cable while the cable is in an extended position in response to the plug being connected to an electric vehicle.

According to another aspect of the disclosed technology, there is provided a method for operating an electric charging station for an electric vehicle, the method comprising: placing a cable in a free pulling zone for displacing freely into the electric charging station and restricting movement of a charging cable when the charging cable is placed into a braking zone of a braking device located at a cable outlet of the electric charging station, a braking friction applied to the charging cable in the braking zone being higher than a free-moving friction applied to the charging cable in the free pulling zone.

A charging station for an electric vehicle may comprise the cable management system as described herein.

A cable management system for an electric charging station for an electric vehicle and a method for managing a cable of a charging station are provided. The cable management system comprises a braking device located at a cable outlet of the electric charging station, the braking device having a free pulling zone having free pulling bristles and a braking zone having braking bristles, the braking bristles being stiffer than the free pulling bristles and the braking bristles being configured to at least partially immobilize a charging cable outside of the cable outlet of the electric charging station by applying friction to the charging cable to brake any movement of the cable into the charging station during charging of the electric vehicle, the friction applied to the charging cable by the braking bristles being higher than by the free pulling bristles.

### BRIEF DESCRIPTION OF THE DRAWINGS

Further features and advantages of the present disclosure will become apparent from the following detailed description, taken in combination with the appended drawings, in which:

FIGS. 1A and 1B illustrate conventional (prior art) storage and use of the charging cable;

FIG. 1C is a perspective view of a charging system for electric vehicles, in accordance with various embodiments of the present disclosure;

FIG. 2A illustrates a front view of a charging station, in accordance with at least one embodiment of the present disclosure;

FIG. 2B illustrates a side view of the charging station of FIG. 2A;

FIG. 2C illustrates a perspective exploded view of the charging station of FIG. 2A;

FIG. 2D illustrates a partial side view A of the charging station of FIG. 2B;

FIG. 3A illustrates a partial perspective exploded perspective view of the base and the side pillars and the cable releasing system and the cable of the charging station of FIG. 2A;

FIG. 3B illustrates a partial exploded perspective view of the cable releasing system of FIG. 3A;

FIG. 3C illustrates a partial exploded perspective view of the charging station of FIG. 2A;

FIG. 4A illustrates a perspective view of the cable releasing system as provided in prior art;

FIG. 4B illustrates a perspective view of the wheel of the cable releasing system of FIG. 4A;

FIG. 5A illustrates a perspective view of the first mobile pulley plate, in accordance with at least one embodiment of the present disclosure;

FIG. 5B illustrates a cable wheel for the mobile pulley system, in accordance with at least one embodiment of the present disclosure;

FIG. 5C illustrates a partial perspective view of the mobile pulley system, in accordance with at least one embodiment of the present disclosure;

FIG. 5D illustrates a partial perspective view of the fixed pulley system, in accordance with at least one embodiment of the present disclosure;

FIG. 5E illustrates a side view of the cable wheel of FIG. 5B;

FIGS. 6A-6C illustrate the mobile pulley system, in accordance with various embodiments of the present disclosure;

FIGS. 7A-7C illustrate the mobile pulley system, in accordance with various embodiments of the present disclosure;

FIG. 7D illustrates sliders, in accordance with at least one embodiment of the present disclosure;

FIG. 7E illustrates a side view of a straight roller, in accordance with various embodiments of the present disclosure;

FIG. 7F illustrates a side view of a tapered roller, in accordance with various embodiments of the present disclosure;

FIGS. 8A-10D illustrate a braking device and various parts thereof, in accordance with various embodiment of the present disclosure;

FIGS. 11A-11F illustrate a plug holder and an anchor, in accordance with various embodiment of the present disclosure;

FIGS. 12A-12D illustrate a charger and a power box in the charging system of FIG. 2A, in accordance with various embodiment of the present disclosure;

FIG. 13 illustrates a method of operation of the charging station, in accordance with various embodiment of the present disclosure; and

FIG. 14 illustrates other steps of the method of operation of the charging station of FIG. 13, in accordance with various embodiment of the present disclosure;

FIGS. 15A-15B illustrate the interplay between a lock and an anchor of the charging station of FIG. 2A, in accordance with various embodiment of the present disclosure;

FIG. 15C illustrates a mechanical lock, in accordance with at least one embodiment of the present disclosure;

FIG. 15D illustrates an additional mechanical braking system, in accordance with at least one embodiment of the present disclosure;

FIG. 16 illustrates another embodiment of the method of operation of the charging station; and

FIGS. 17A-17B illustrate a mechanical lock and operation of the mechanical lock, in accordance with at least one embodiment of the present disclosure;

FIG. 17C illustrates the mechanical lock of FIG. 17A in a locked state (position), in accordance with at least one embodiment of the present disclosure; and

FIG. 17D illustrates the mechanical lock of FIG. 17A in an unlocked state (position), in accordance with at least one embodiment of the present disclosure.

It will be noted that throughout the appended drawings, like features are identified by like reference numerals.

### DETAILED DESCRIPTION

Various aspects of the present disclosure generally address one or more of the problems of damaging a charging cable of an electric vehicle (EV) charging system. Such damaging of the charging cable may occur during the charging of the EV and in between of the charging sessions.

There is described a system and a method for reducing movement of the charging cable and immobilizing of the charging cable during the charging and in between of the charging sessions.

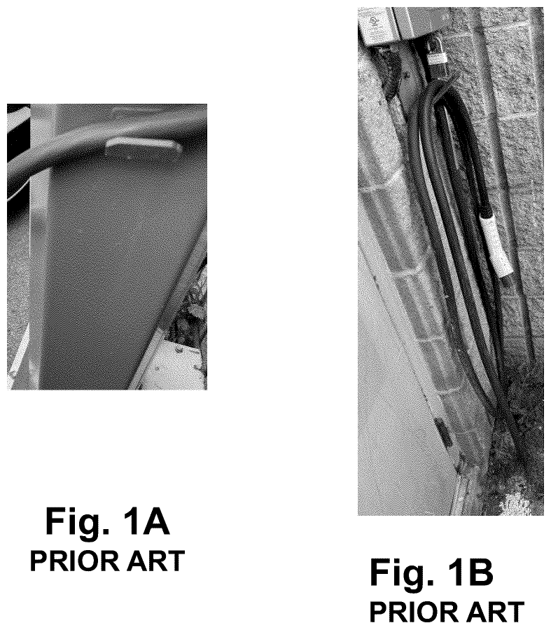

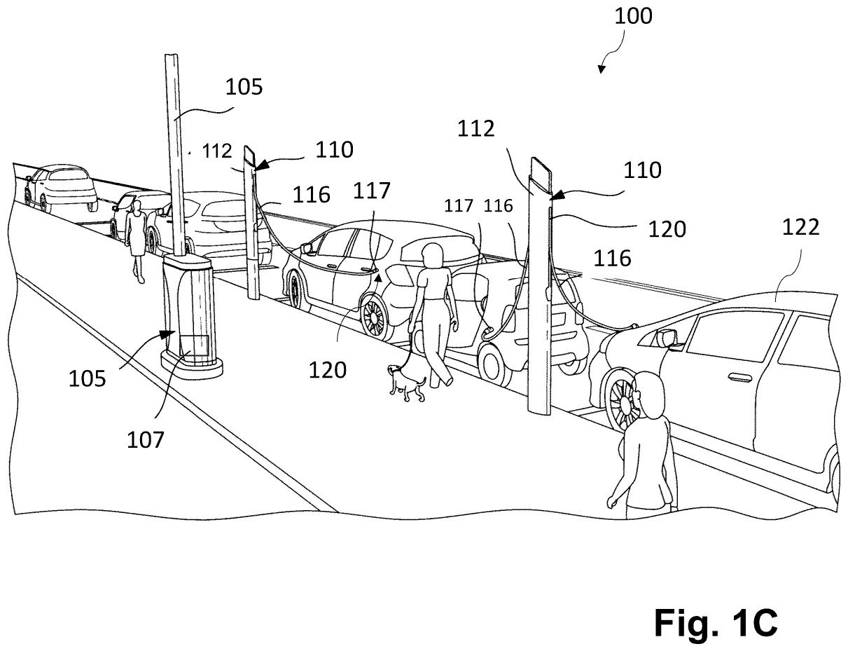

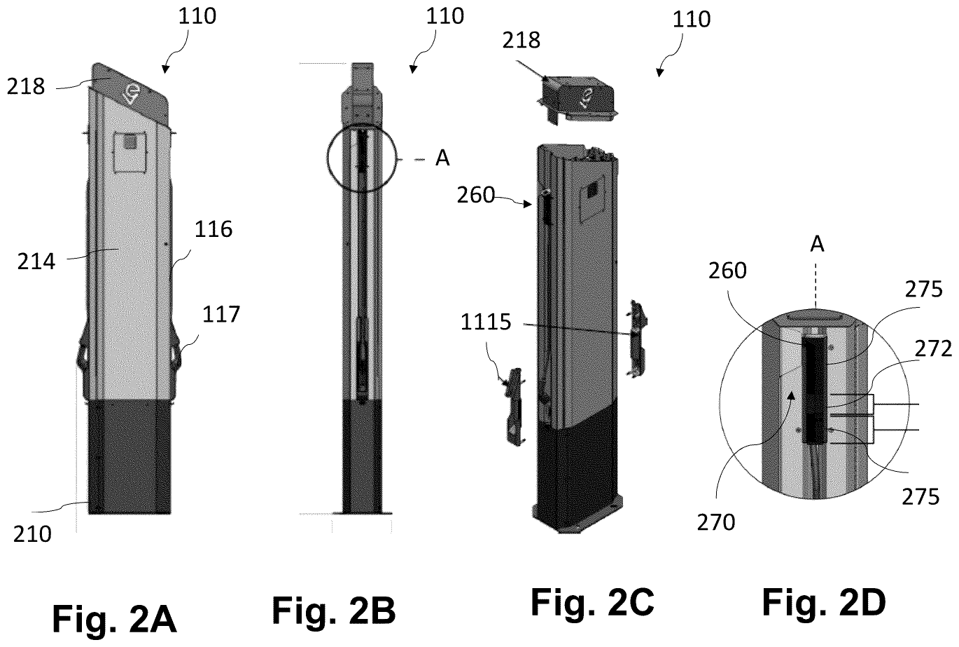

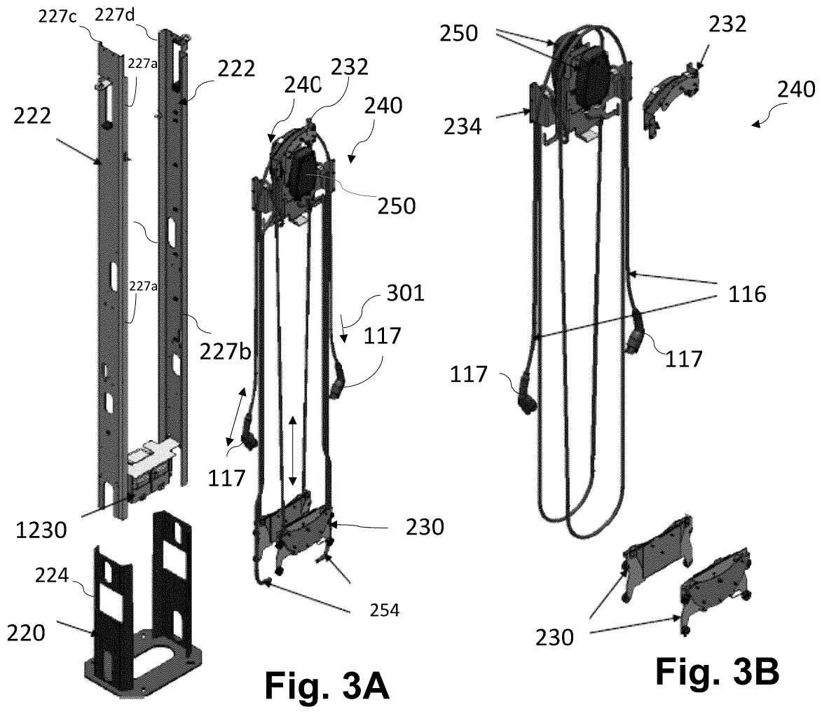

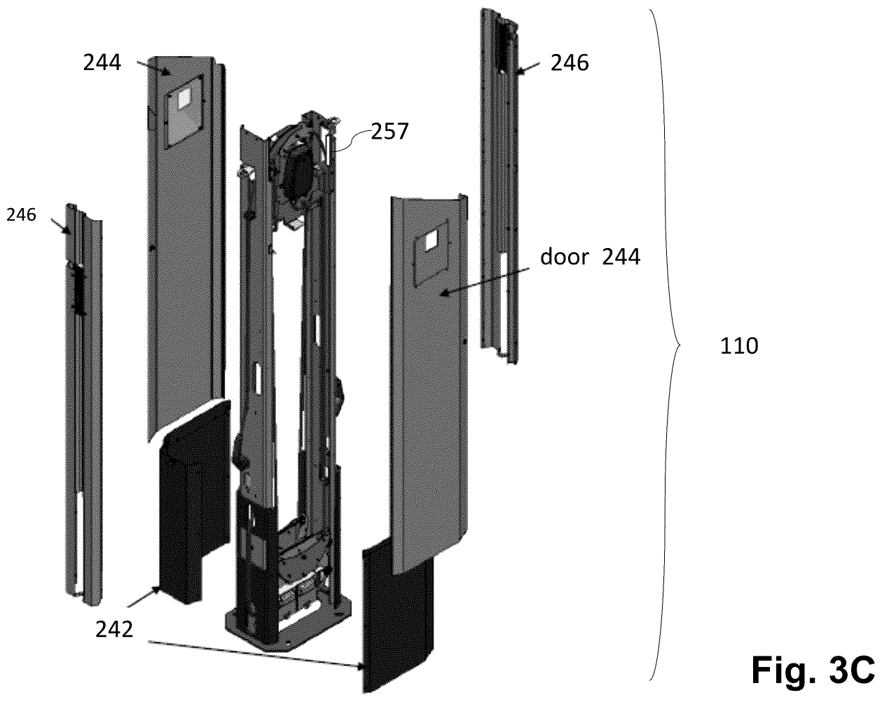

Referring now to the drawings, FIG. 1C illustrates one possible example of a centralized version of an EV charging system 100. The charging system 100 generally comprises a master charger unit 105 adapted to be operatively coupled to a given number of charging stations 110 (two in the illustrated embodiment). Each charging station 110 comprises an elongated upstanding enclosure 112 housing at least one charging cable 116 (also referred to herein as a “cable 116”). There are two charging cables 116 in the embodiment illustrated in FIGS. 2A-3B. A free end of the charging cable 116 has an EV charging plug 117 (which may be also referred to as a “charging head 117” or a “gun”) for connection with an EV charging socket 120 (also referred to herein as an “EV's plug receiver 120”) of an EV 122.

The master charger unit 105 may comprise a properly sized cabinet housing with a complete electrical entrance with power and a breaker panel, along with a charger unit and control relays. The master charger unit 105 may also comprise a user interface. The master charger unit 105 may be operatively connected to a plurality of remotely disposed charging stations 110. The master unit 105 may have a structure and operate similar to the master unit described in patent publication No. WO2016/008045, which is incorporated herein in its entirety.

The charging stations 110 may be positioned so that the charging cables 116 are accessible on the street side where they may be connected to the EV while being properly housed inside adequate yet less cumbersome enclosures.

Referring now to FIGS. 2A-2C and 3A-3C, in at least one embodiment, the charging station 110 may comprise a base 210, a body 214 and a hood 218. As illustrated in FIGS. 3A-3C, the base 210 may comprise a base stand 220 that can hold two side pillars 222. The side pillars 222 are attached to supporting (base) pillars 224 of the base stand 220 and have power boxes 1230 in between them. The assembly of the side pillars 222 and base stand 220 (illustrated in FIG. 2B) is covered with base panels 242, doors 244, and cable panels 246 illustrated in FIG. 3C.

As illustrated in FIG. 3A, each side pillar 222 is located opposite of the other side pillar 222 and has two ledges 227 (227a, 227c or 227b, 227d) which project towards the other pillar 222. FIGS. 2A and 3B illustrate that the charging station 110 may have two cable extension systems 240, positioned one over another such that each cable 116 may be pulled out towards one side of the charging station 110 (opposite to the other side from which the other cable may be pulled from the other cable extension system 240). The cable extension system 240 comprises a fixed pulley system 232, a mobile pulley system 230, a charger 250, and a cable 116 having the plug 117. One charging station 110 may have two cable extension systems 240.

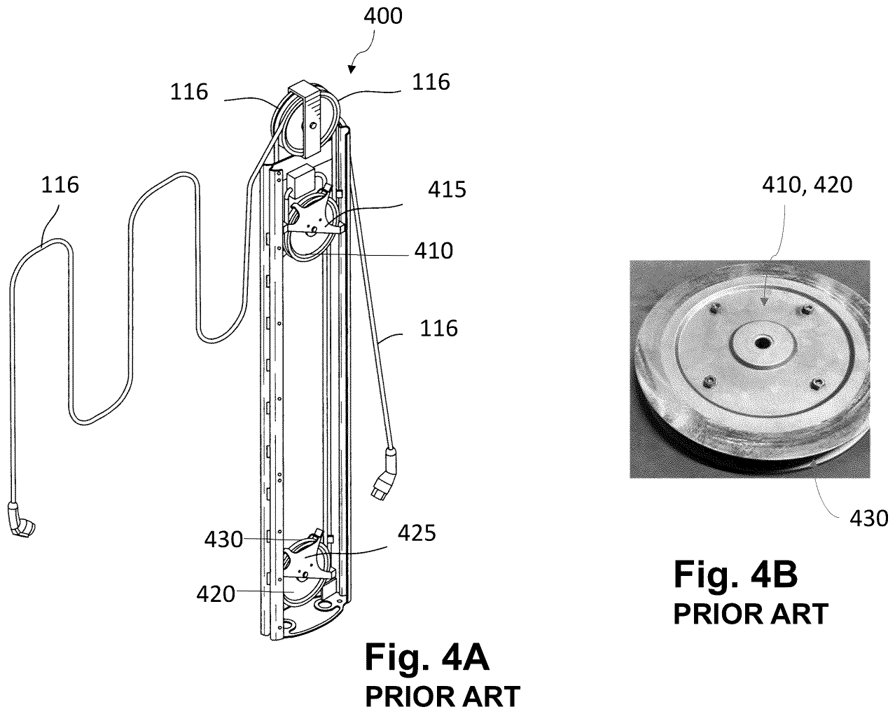

FIG. 4A illustrates a prior art cable system 400 having two pulleys for the EV charging station. As can be seen in FIGS. 4A, 4B, prior art cable system 400 comprises a fixed pulley bulky wheel 410 in the fixed pulley 415 and a mobile pulley bulky wheel 420 in the mobile pulley 425. Two bulky wheels—fixed pulley bulky wheel 410 and the mobile pulley bulky wheel 420—are arranged such that the cable 116 may travel within their side grooves 430, located on a periphery of these fixed and mobile pulley bulky wheels 410, 420.

Instead of having the fixed pulley bulky wheel 410 and the mobile pulley bulky wheel 420 of the prior art cable system 400 (FIGS. 4A and 4B), in at least one embodiment of the charging station disclosed herein, the two cable extension systems 240 are the fixed pulley system 232 (which may be also referred to as an “upper pulley system” or an “upper pulley assembly” or a “fixed pulley assembly”) and the mobile pulley system 230 (which may be also referred to as a “lower pulley assembly” or “lower pulley system” or a “mobile pulley assembly” or a “mobile trolley”), which are located in between the side pillars 222.

The fixed pulley system 232 is immobile relative to the charging station 110 and the ledges 227 of the pillars 222 and is located higher than the mobile pulley system 230.

The mobile pulley system 230 is configured to travel between the power box 1230 (shown in FIG. 3A) and the fixed pulley system 232 of the charging station 110. The two ledges 227 of the side pillar 222, positioned opposite of each other, act as rails (and can be also referred to as “rails 227”) that help the mobile pulley system 230 to travel up and down along the ledges 227 of the side pillars 222. Referring to FIG. 3B, the mobile pulley system 230 moves up and down by engaging with the ledges 227a, 227b. At the same time, when the charging station 110 has the second cable extension system 240, the mobile pulley system 230 engages with the other pair of ledges 227c, 227d of the side pillars 222.

The charging cable 116 passes through the mobile pulley system 230 and the fixed pulley system 232. The charging cable 116 may be extended outside the charging station 110 simultaneously with the mobile pulley system 230 travelling up the pillars 222 towards the fixed pulley system 232. When the charging cable 116 is pushed into the charging station 110, the weight of the mobile pulley system 230 helps the charging cable 116 to move into (inside) the charging station 110 while, at the same time, rewinding the cable 116 and retracting the cable 116 into the charging station 110.

Referring to FIG. 3A, when the charging cable 116 is extended from the charging station 110, the pulling force that needs to be applied to the cable 116 for such extension of the cable 116 is higher than the force of gravity of the mobile pulley system 230 that holds a portion of the cable 116. By applying, to the charging cable 116, the pulling force towards outside of the charging station 110 (arrow 301) such that that pulling force is higher than the force of gravity of the mobile pulley system 230, the user extends the cable 116 outside of the charging station 110, and, simultaneously, the mobile pulley system 230 is moved up, because the length of the cable 116 located inside of the charging station 110 is reduced.

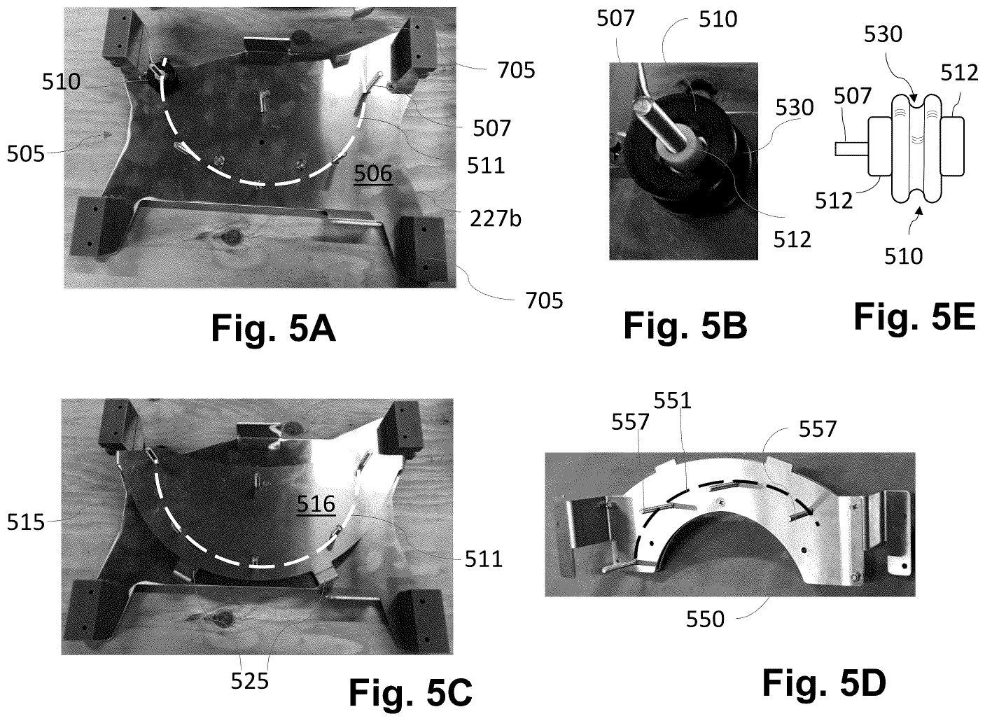

When extending, the cable 116 travels over (rolls over) freely rotating cable wheels 510 (illustrated in FIGS. 5A, 5B) in the fixed pulley system 232 and, in the mobile pulley system 230, the cable 116 (travels over) rolls over the freely rotating cable wheels 510 of the mobile pulley system 230, discussed further below.

In at least one embodiment of the charging station 110 described herein, the fixed pulley system 232 and the mobile pulley system 230 each comprises a set of cable wheels 510 located on or about an arc of an imaginary circle (which may also be referred to as a portion of an imaginary circumference). The lower pulley system 230 has a mobile imaginary arc 511, illustrated in FIGS. 5A-5B. FIG. 5A also illustrates a first mobile pulley plate 505 with rods 507 (which may be threaded, such as, for example, bolts), in accordance with at least one embodiment of the present description.

Each cable wheel 510 sits on the threaded rod 507 (or a bolt) that is positioned approximately perpendicular to a plate's surface 506 of the first mobile pulley plate 505 and perpendicular to the direction of travelling of the mobile pulley system 230.

Each threaded rod 507 has one cable wheel 510 thereon, illustrated in FIGS. 5B and 5E. As illustrated in FIG. 5B, each one of the cable wheels 510 has a cable groove 530 on a periphery (edge) of the cable wheel 510 for receiving a portion of the cable 116, permitting the cable 116 to be moved (rolled about). The cable wheels 510 may be made, for example, from caoutchouc, to encourage friction of the cable wheels 510 with the charging cable 116 (which may have, for example, a caoutchouc outside layer) in order to improve coupling (adhesion force) of the cable with the cable wheels 510 and therefore the efficiency (the speed) of pulling the cable 116 out of the charging station 110.

A second mobile plate 515 (illustrated in FIG. 5C) is placed over the first mobile plate 505 (illustrated in FIG. 5A). Cable holders 525 (illustrated in FIG. 5C) may be positioned on the first and/or the second mobile plates 505, 515 in order to hold the cable 116 close to the cable wheels 510 and to maintain the cable's trajectory along the mobile imaginary arc 511.

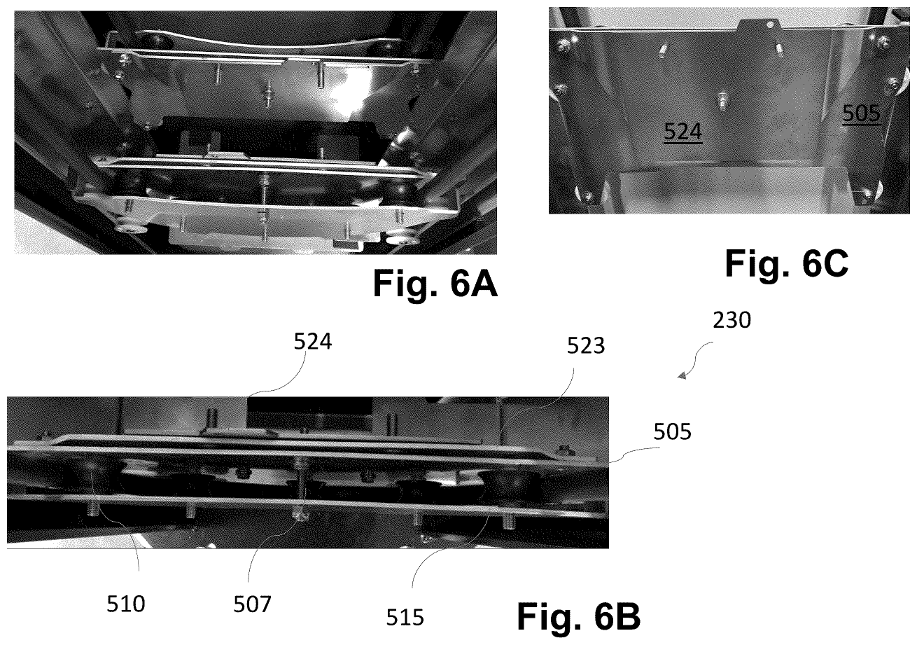

There are many advantages of having the set of cable wheels 510 (as described herein and illustrated in FIG. 5A-6B) instead of one pulley wheel (illustrated in FIGS. 4A-4B). Using the set of cable wheels 510 allows keeping the mobile imaginary arc 511 of the trajectory of the cable 116 large (for example, the mobile imaginary arc 511 may be of a diameter of 20 centimeters), the total size of the first mobile pulley plate 505 and the second mobile plate 515 may be approximately half of the full area of the circumference on which the mobile imaginary arc 511 lies, permitting to provide higher reach of the mobile pulley system 230 when it is moved all the way up towards the fixed pulley system 232, therefore increasing an available length of the cable 116 that may be pulled out of the charging station 110. Having several smaller cable wheels 510 instead of one larger wheel 430 (as in FIGS. 4A-4B) permits reducing and controlling the weight of the mobile pulley system 230, as well as reducing and controlling the area that the mobile pulley system 230 spreads over in the two cable extension systems 240. Reduced overall area of the mobile pulley system 230 permits the mobile pulley system 230 to reach higher up along the ledges 227 of the side pillars 222 and therefore permits extending the cable 116 further away outside of the charging station 110.

The threaded rods 507 are attached to the first mobile pulley plate 505 and the cable wheels 510 are located between the first mobile pulley plate 505 and the second mobile plate 515. For each pair of the threaded rod 507 and the cable wheel 510, two smaller spacers 512 (implemented as, for example, wheels of smaller diameter than the cable wheel 510 as illustrated in FIG. 5B) separate the cable wheel 510 from the first mobile pulley plate 505 and the second mobile plate 515 for improved rotation and reduced friction with the first mobile pulley plate 505 and second mobile plate 515.

FIG. 5D illustrates a first fixed plate 550 of the fixed pulley system 232, in accordance with at least one embodiment of the present disclosure. The first fixed plate 550 has threaded rods 557 that are also located on a fixed imaginary arc 551. This fixed imaginary arc 551 has a central axis that is located above a central axis of the mobile imaginary arc 511 of the mobile pulley system 230. Each one of a second set of cable wheels 510 are positioned on or about the fixed imaginary arc 551. The second set of cable wheels 510 is located between the first fixed plate 550 and a second fixed plate (not shown) which form, along with the second set of cable wheels 510, the fixed pulley system 232 of FIG. 3B.

Cable grooves 530 of the cable wheels 510 permit the cable 116 to be moved along the fixed imaginary arc 551 when the cable 116 is pulled out of the charging station 110 and when the cable 116 is slightly pushed into the charging station 110. As can be seen in FIG. 5D, the first fixed plate 550 may have a form that allows the threaded rods 557 and the cable wheels 510 be positioned along the fixed imaginary arc 551, have strength appropriate to hold the cable 116. The area covered by the first fixed plate 550, however, may be significantly less than would be an area covered by one large wheel 410, 420 which would have the fixed imaginary arc 551 on its periphery. Using the sets of the cable wheels 510 allows for space economy of the mobile pulley system 230 and fixed pulley system 232 inside the charging station 110.

Space economy in the mobile pulley system 230 and fixed pulley system 232 allows the charger bracket to be installed higher, which allows more room for the mobile trolley 230 to travel higher, which ultimately allows for a longer usable length of the cable 116. This extra room also allows the possibility for the integration of bigger models of EV charger inside the charging station 110. Without such an extra room, bigger EV charger would have a limit (would provide a constraint for) the usable length of the cable 116. For example, the total length of the EV charger's connector cable may be limited at 25′ due to standards and certifications. The space economy provided by the use of the cable wheels 510 (instead of the bulky pulley 420) allows to increase the usable length of the cable 116. In other words, the length of the cable 116 that may be pulled out of the charging station 110 may be increased. Additionally, the set of the cable wheels 510 instead of the bulky pulley 420 also allows for an easy access for maintenance.

Referring to FIGS. 6A, 6B, in at least one embodiment, weights may be attached to the first mobile pulley plate 505 and/or the second mobile plate 515 as needed. The weights 523, 524 (which may be also referred to as “weight objects”) are generally flat and have shape similar to (or complimentary to) the first mobile pulley plate 505 and/or second mobile plate 515 in order for the weight to be distributed evenly on the lower pulley plate 505 and the lower pulley cover 515, respectively. The weight objects 523, 524 may have one or more convexity and/or deepening but they are preferably flat and may be referred in such preferred embodiments as “weight plates 523. 524”. In at least one embodiment, each weight object 524 may weigh, for example, approximately 1000 g or 330 g. The options of weight of approximately 1000 g and 330 g allow for improved control of the weight of the movable pulley system 230 for calibrating the operation of the pulling out of the cable 116 from and retracting of the cable 116 into the charging station 110. A bracket 523 is configured to hold carriage bolts 507 in place within the mobile trolley system (movable pulley system 230). The weight plates 523, 524 are preferably made of aluminum, although other materials may be used. For example, two or more plates 523, 524 may be added to the mobile pulley system 230. The weight of the mobile pulley system 230 may be fine-tuned by adding more or less of the weight plates 523, 524. The weight of the mobile pulley system 230 defines the force with which the cable 116 needs to be pulled by the user to extend the cable 116 from the charging station 110, and also the force applied to the cable 116 by the mobile pulley system 230 when the EV is being charged, and how fast the cable 116 may be retracted into the charging station 110 after the charging plug 117 is unplugged from the EV and the cable 116 is released from a braking system 270 described herein below.

When the EV is being charged, and the cable 116 is engaged by the braking system 270 described below, the retracting force provided by the weight of the mobile pulley system 230 should not be stronger than the friction provided by the braking system 270, in order to maintain the cable 116 fixed by the braking system 270 and to avoid undesirable retraction force applied to the cable 116 with the charging head 117, and to protect the cable 116 and the charging head 117 from damaging by such a cable retraction force. Therefore, based on such an interplay between the braking system 270 and the weight of the mobile pulley system 230, the number of the weight plates 523, 524 attached to the mobile pulley system 230 may be determined before the weight plates 523, 524 are added to the mobile pulley system 230.

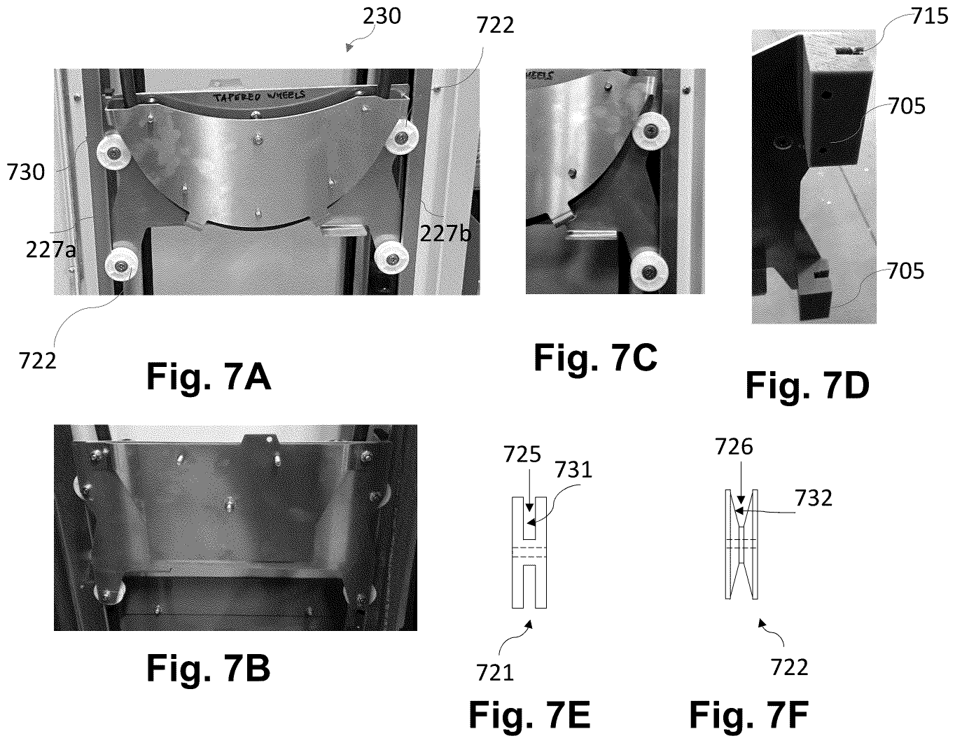

The mobile pulley system 230 slides up and down the side pillars 222 using a set of sliders 705 as illustrated, for example, in FIGS. 5A and 7D. The sliders 705, illustrated also in FIG. 7D, have grooves 715 that are complementary to the ledges 227 of the side pillars 222.

FIGS. 7A, 7C illustrate that the mobile pulley system 230 may also slide up and down the side pillars 222 using a set of rollers which also referred to herein as a set of straight rollers 721 or a set of tapered rollers 722. For example, the mobile pulley system 230 may have four rollers: four straight rollers 721 or four tapered rollers 722. The rollers 721 or 722 may be located fully or partially below the cable's trajectory inside the mobile pulley system 230.

In at least one embodiment, the lower pulley system 230 has at least four rollers 721 or 722 that help the lower pulley system 230 to travel up and down of the charging station 110.

Each roller 721, 722 has a groove 725, 726 for receiving a portion of the ledge 227a or 227b (see FIG. 7A) over which the roller 721, 722 may slide. FIG. 7E illustrates a side view of a roller 721, 722 and its two embodiments: a first embodiment of the roller 721 and a second embodiment of the roller 722. The first embodiment of the roller 721 (which is also referred to herein as a “straight roller”) has a straight groove 725 and may be referred to as the straight roller 721. The first embodiment of the roller 721 has straight groove 725 with straight inner surface 731 which is approximately parallel to the surface of the ledge 227. The straight groove 725 slides over the ledge 227, and the straight surface 731 contacts the ledge 227 over the whole or almost whole straight inner surface 731 when the roller 721 is moving (sliding over it).

An alternative (second) embodiment of the roller, tapered roller 722, has a tapered groove 726 and a tapered inner surface 732, as illustrated in FIG. 7F. The rollers 722 with the tapered groove 726 have the inner surface of the roller 722 which is not parallel to the rail (ledge 227), but located at (positioned at) an angle that is larger than zero degrees and less than 90 degrees (with respect to the outside surface 730 of the ledge 227). The tapered inner surface 732 and the tapered groove 726 permits to reduce the contact area of the tapered roller 722 and the ledges 227 and therefore to reduce the friction of the rollers 722 when they slide over the ledges 227.

In addition, the tapered internal surface 732 may help to ignore any roughness/unevenness that may be formed on the ledges 227 due to changes in the ambient temperature. The roughness that may be formed on the ledges 227 may result in additional friction to the straight rollers 721 when they slide over the ledges 227. Tapered rollers 722 may help to reduce such friction. The lower pulley system 230 having four rollers 721, 722 permit maintaining the smooth movement of the lower pulley system 230 up and down the ledges 227.

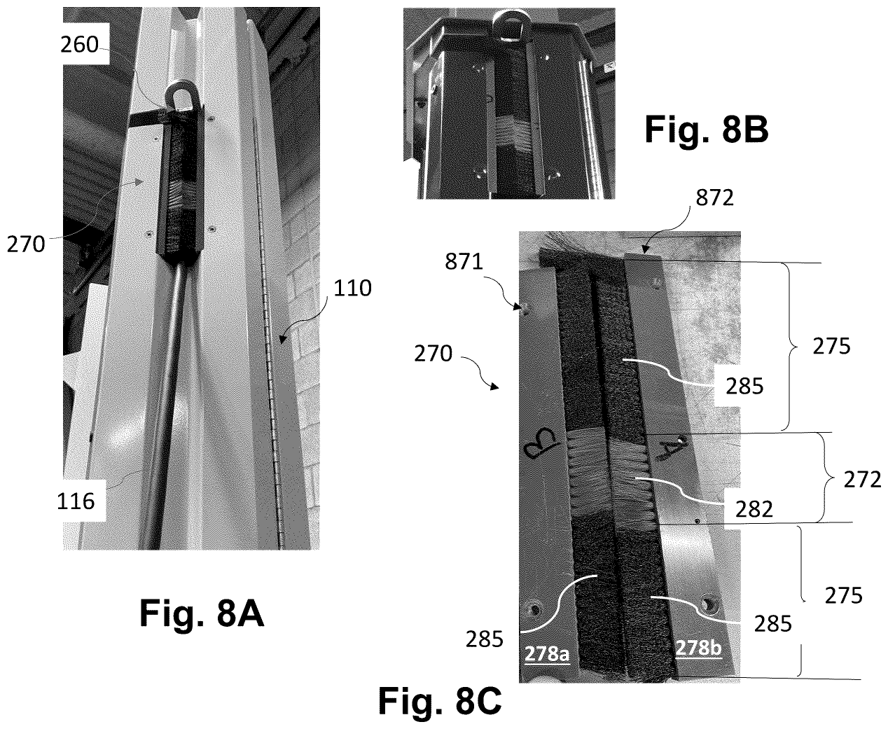

Referring to FIGS. 8A-8C, in at least one embodiment, the charging station 110 further comprises a cable outlet 260 located in a vicinity of a braking device 270 (which may be also referred to as a “braking system 270”). The braking device 270 comprises a braking zone 272 and at least one free pulling zone 275, located next to the braking zone 272. In the embodiment with two free pulling zones 275, the braking zone 272 is located in between of the two free pulling zones 275.

In a non-limiting example of implementation, the braking zone 272 of the braking device 270 may have braking bristles 282 and the free pulling zone 275 may have free pulling bristles 285. During operation, the cable 116 is pulled through the free pulling zone 275 and therefore through the free pulling bristles 285, and, when the length of the cable 116 has been chosen (such as, for example, the length of the cable 116 being enough to reach the EV and to plug the cable head 117 to the vehicle charging outlet), the cable 116 is placed by the user (for example, by jerking/pulling/moving a portion of the cable 116 up or down from the free pulling zone 275) into the braking zone 272 to prevent the cable 116 from moving up or down during the charging. The friction applied to the cable 116 by the braking bristles 282 of the braking zone 272 of the braking device 270 (also referred to as “braking friction”) when the cable 116 is located in the braking zone 272 is higher than the friction applied to the cable 116 by the free pulling bristles 285 (also referred to herein as “free-moving friction” to distinguish from the “braking friction” applied by the braking bristles 282) when the cable 116 is located in the free pulling zone 275.

Preferably, the braking bristles 282 are stiffer than the free pulling bristles 285 to be able to hold the cable 116 in place and outweigh the portion of the cable 116 and plug that extends outside the EV charging station 110. For example, the braking bristles 282 may have the diameter larger than the diameter of the free pulling bristles 285. In other terms, the braking bristles 282 are thicker than the free pulling bristles 285 to be able to hold the cable 116 in place and outweigh the portion of the cable 116 and plug that extends outside the EV charging station 110. In a non-limiting example of implementation, the diameter of the braking bristles 282 may be approximately 0.012 inches and the diameter of the free pulling bristles 285 may be approximately 0.008 inches. The free pulling bristles 285 may be curled to obtain even less friction applied to the cable 116 when it passes through the braking device 270. In addition, or alternatively, the braking bristles 282 and free pulling bristles 285 may be made of different materials, such that the braking bristles 282 would apply higher friction force on to the cable 116 when it passes through the braking device 270. In other words, the friction applied to the charging cable 116 by the braking bristles 282 is higher than the friction applied to the charging cable 116 by the free pulling bristles.

In at least one embodiment, the braking bristles 282 and the free pulling bristles 285 may have different color, for example, black for free pulling bristles 285 and red for braking bristles 282, so that the user may distinguish between the braking zone and the free pulling zone. The braking bristles 282 and the free pulling bristles 285 are attached to bristle holders 278a, 278b with which they form two braking brooms 871, 872 (which may be also referred to as a first braking brush 871 and a second braking brush 872 or, collectively braking brushes 871, 872).

The braking zone 272 of two braking brooms 871, 872 may form a narrow or even negligible bristles gap 875 between bristles the two braking brooms 871, 872 and the cable 116 may be located within the braking zone 272, and the braking zone 272 may provide friction that can hold the cable 116.

When the cable 116 is located in the free pulling zones 275, the cable 116 may move freely in and out of the cable outlet 260 of the charging station 110, and when a portion of the cable 116 is placed into the braking zone 272, the cable 116 slows down by the friction provided by the braking bristles 282 and the cable 116 is held still by the braking bristles 282 so that an additional force needs to be applied to pull the cable 116 out of or into the charging station 110. Such an additional force which holds the cable 116 in place may be stronger than the wind (that may have pulled the cable 116 if there would not be the braking bristles 282 and the braking zone 272 as described herein) and/or the force provided by the cable 116 itself due to, for example, its weight.

In another embodiment, in addition to braking bristles 282, the braking system 270 may have a couple of braking blocks 880a, 880b that are configured to help the braking bristles 282 of the braking device 270 to slow down and immobilize (hold) the cable 116. The two braking brooms 871 may have braking blocks 880a, 880b which may be made of caoutchouc/wood (or a combination of different materials) and may be located behind the braking bristles 282 (in other words, the braking blocks 880a, 880b may be located towards the inner side of the charging station 110).

The braking blocks 880a, 880b may be also placed in front of the brooms 871, 872, i.e. the braking blocks 880a, 880b may be located on the outer side of the brooms 871, 872 with respect to the charging station 110. The braking bristles 282 also, by having a different color (for example, red or orange) than the free pulling bristles 285, indicate to the user where the braking zone 272 is located. Brooms 871, 872 with bristles 282, 285 may also serve as a barrier from the insects and small animals so that they cannot get inside (into the interior) the charging station 110. They also help to limit the infiltration of dust, debris and water into the interior of the charging station.

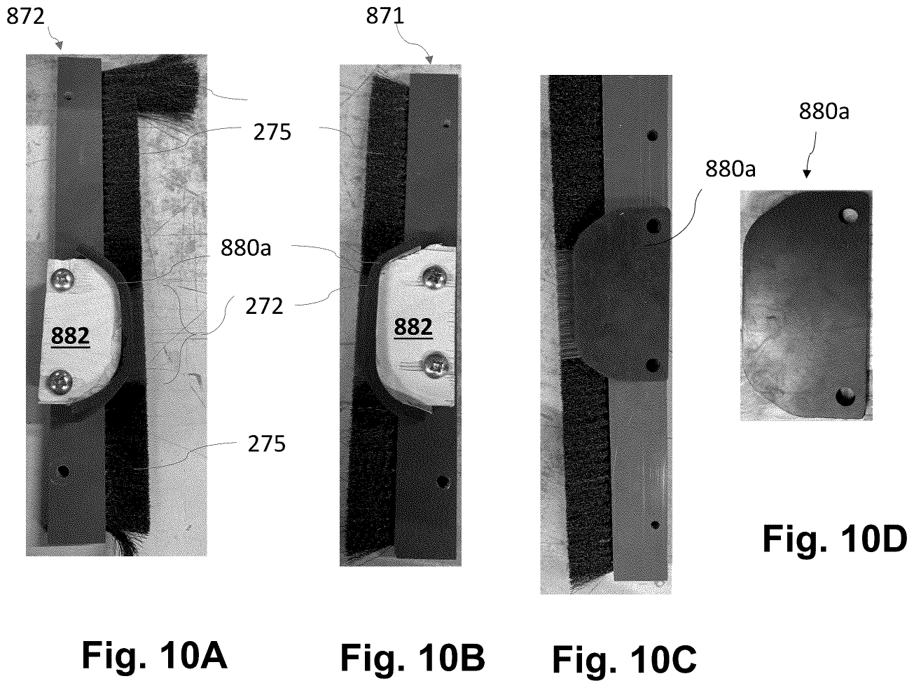

Variants of the braking blocks 880a, 880b are illustrated in FIGS. 10A-10D. In at least one embodiment, one or both braking blocks 880a, 880b may be made of a wooden plate 882 surrounded by a layer of caoutchouc or another material that can provide additional friction to the cable 116.

The combination of the blocks 880a, 880b and the braking bristles 282 provide friction to the cable 116 and does not damage the cable 116 when the cable 116 is pulled through a gap formed by and between the blocks 880a, 880b. Such a gap (which may be referred to as a “block gap”) formed by the blocks is wider than the bristles gap 875 formed by the braking bristles 282, while the bristles gap 875 formed by the braking bristles 282 may be negligible and the cable 116 may be located within the braking zone 272 (within the plurality of the braking bristles 282) and the braking bristles 282 may provide friction and hold (immobilize) the cable 116.

Accordingly, the braking device 270 allows to slow down and eventually brake any rewind of the cable 116 back into charging station 110 through the cable outlet 260. This also allows for reducing tension and jerking applied by the cable 116 onto the vehicle's plug receiver during the charging of the EV 122 which eventually results in damaging the EV's plug receiver 120 over time. Often, when drivers park the EV 122 far from the charging station 110 or apply high tension onto the cable 116 in order to reach the EV's plug receiver 120 to insert the charging plug 117 therein. This tension of the charging cable 116 coupled with wind or other factors often results in damaging the EV's plug receiver 120.

An additional mechanical braking system 257 (which may also be referred to as “additional mechanical cable braking system 257”) may be also added to the braking device 270. The additional mechanical braking system may be activated automatically when the user connects the charging plug 117 to the EV 122. Such an additional mechanical braking system 257 may help to reduce and/or eliminate the tension, as long as the charging plug 117 is connected to the EV 122. As soon as the user disconnects the charging plug 117 from the EV 122, the braking stops automatically. This may help to reduce the user's responsibility for the braking system and reduce the misuse of the system.

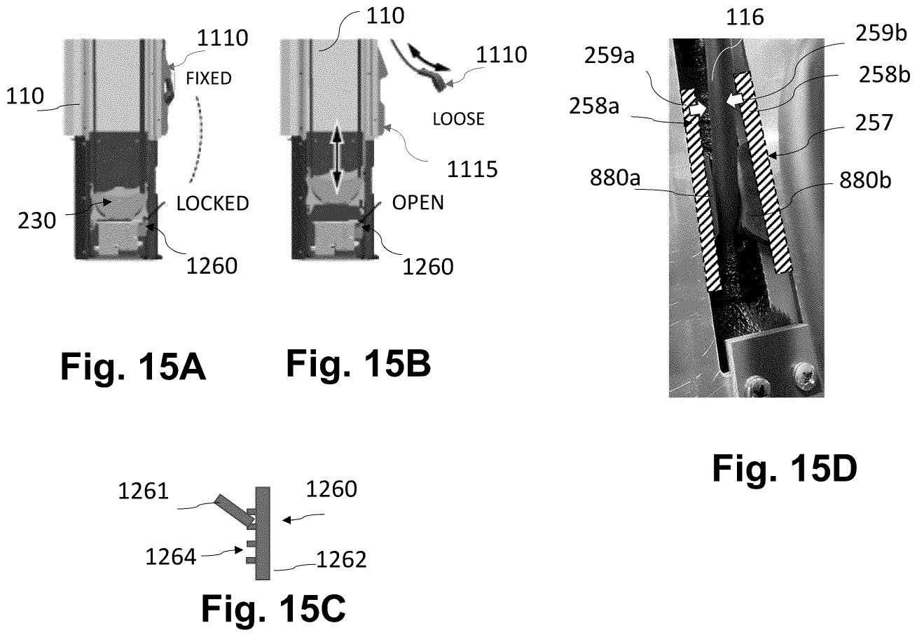

A non-limiting example of the additional mechanical braking system 257 is illustrated in FIG. 15D. The additional mechanical braking system 257 may be any mechanical means that permits to mechanically block (retain) the cable 116 and prevent the cable 116 from moving with respect to the additional mechanical braking system 257 in response to receiving an indication that the charging plug 117 is connected to the EV 122 or in response to receiving other indications, such as, for example, the charging has started.

For example, the additional mechanical braking system 257 may have one moving block 258a that is configured to be displaced (moved) along the arrow 259a (in FIG. 15D) when it receives a signal (an indication) that the user has connected the charging plug 117 to the EV 122. In at least one embodiment, there may be two moving blocks 258a, 258b that may move towards each other along the arrows 259a, 259b, respectfully, to pinch the cable therebetween and to prevent it from moving back inside the charging station 110. By displacing the moving blocks 258a, 258b in response to an indication received, for example, from a processor, the additional mechanical braking system 257 is configured to restrict movement of the cable 116 while the cable 116 is in the extended position. Although FIG. 15D illustrates braking blocks 880a, 880b and the additional mechanical braking system 257 being provided simultaneously in one charging station 110, in at least one embodiment the additional mechanical braking system 257 may be provided instead of the braking blocks 880a, 880b in the charging station 110. In other words, in at least one embodiment, the charging station 110 may have the additional mechanical braking system 257 while not having the braking blocks 880a, 880b.

The additional mechanical braking system 257 may be connected to a braking motor with a reduction gear coupled to a spring that compresses the supply wire to retain it, and optical position or switch feedback to indicate proper operation of the additional mechanical braking system 257. The additional mechanical braking system 257 may have two states: active brake and inactive brake. For operational safety reasons, it is preferable to have feedback for each of these two states. Operation of the additional mechanical braking system 257 may be done using an electrical motor/actuator, a magnetically activated system/actuator, a pneumatic system/actuator etc. without departing from the scope of the disclosure as recited in the claims.

The braking device 270 as described herein and, in some embodiments, the braking device 270 in combination with the additional mechanical braking system 257, are configured to mostly to prevent the return of the cable inside the charging station 110. The return of the cable 116 into the charging station 110 may be initiated by automatic retracting due to the gravitational effect on the mobile pulley system 230. Although the cable 116 may not move out by itself, the user may pull the cable 116 out, if the user wants to take more cable 116 outside of the charging station 110, towards the EV 122.

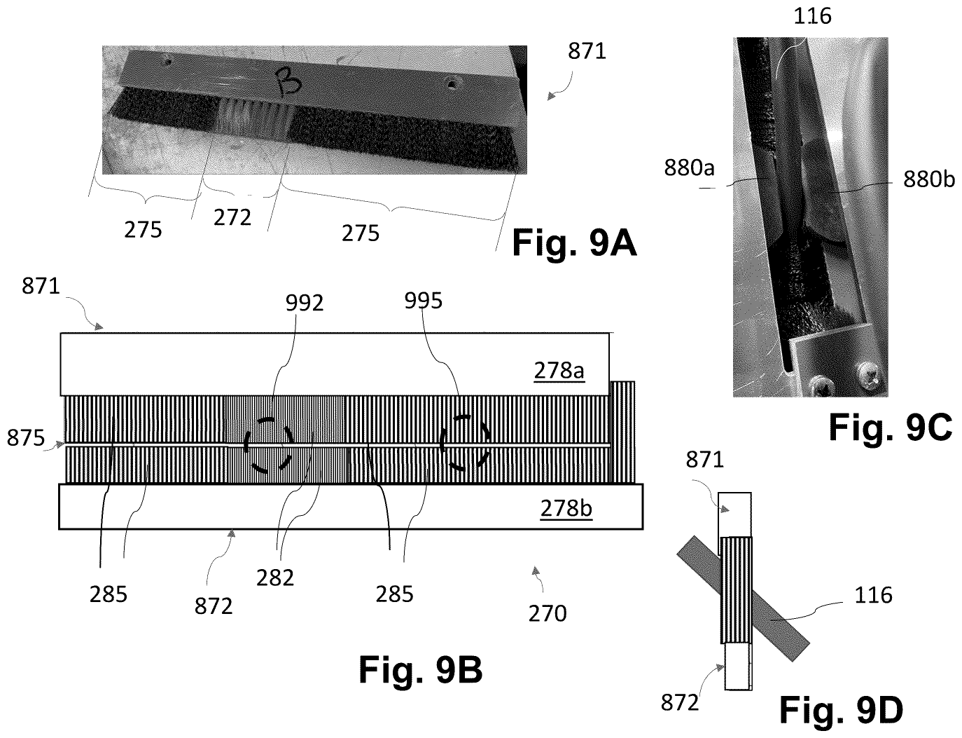

In operation, after the cable 116 is extended outside the cable outlet 260 to a desired length of the cable 116 to reach the EV 122, the cable 117 is passed through the braking zone 272 of the braking device 270. In other words, at least a portion of the cable 116 is pushed or pulled towards the braking zone 272 and located in the braking zone 272 during charging. The cable 116 traverses the braking bristles 282 of the braking zone 272 perpendicularly or at an angle, as illustrated in FIG. 9D. The braking device 270 has the braking zone 272 which provides friction to the cable 116 and reduces, or may eliminate completely, the tension (return tension) applied to the cable 116 by a force produced by the weight of the mobile pulley system 230. The combination of the tension of the braking bristles 282 and pre-determined weight of the mobile pulley system 230 adjusted during the installation of the charging station 110 or at the manufacturing stage, permit reducing the tension applied to (or experienced by) the cable 116 during the charging of the EV 122. Circle 992 in FIG. 9B illustrates the cable 116 located in the braking zone 272. As described above, to increase friction applied to the cable 116, the braking blocks 880a, 880b may be also placed in the braking zone 272.

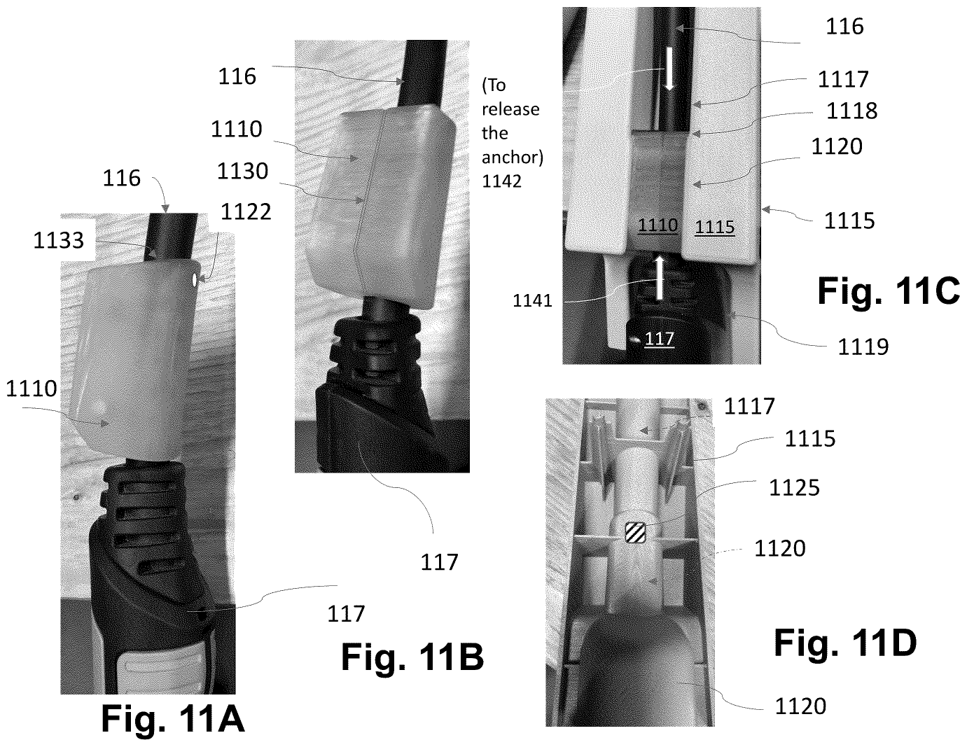

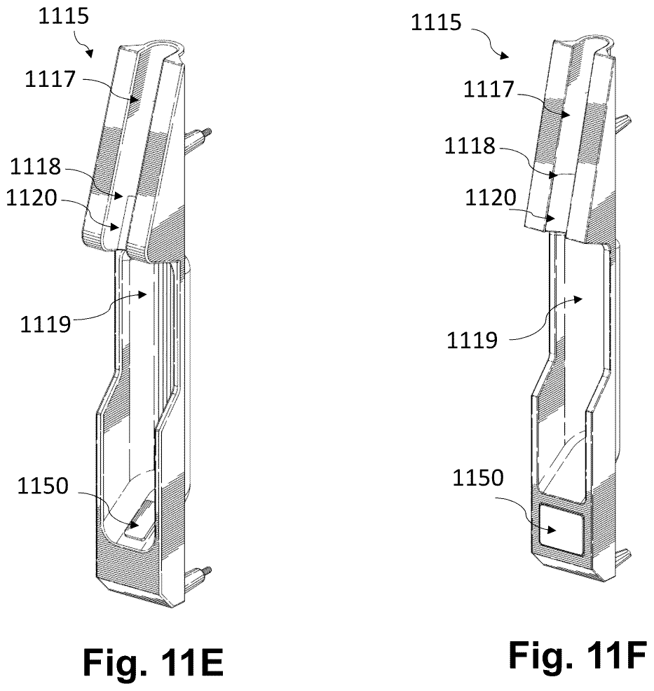

After the EV 122 has been recharged, the cable 116 may be pulled out of the charging station 110 and moved up or down from the braking zone 272 towards the free pulling zone 275 (circle 995 in FIG. 9B illustrates the cable located in the free pulling zone 275). When the cable 116 is within the free pulling zone 275, the cable 116 may move freely out or into the charging station 110. The cable 116 may thus be rewinded into the charging station 110 in order to place the charging plug 117 into a plug holder 1115 illustrated in FIGS. 2C, 11E, 11F.

Referring now to FIGS. 11A-11D, in at least one embodiment, the charging station 110 has an anchor 1110 that is positioned on the cable 116 near the charging plug 117. The anchor 1110 has a shape that is complementary to a portion of a plug holder 1115 of the charging station 110, as illustrated in FIG. 11C. The plug holder 1115 is configured to receive a portion of the cable 116 and the charging plug 117.

The plug holder 1115 has a cable groove 1117 for receiving the cable 116 therein and may have an anchor groove 1120 for receiving therein the anchor 1110 with the cable 116. The diameter of the anchor groove 1120 may be larger than the diameter of the cable groove 1117. This may provide a step 1118 at which the anchor 1110 may abut a portion of the plug holder 1115 when the anchor 1110 is pushed up into the anchor groove 1120 following the arrow 1141. Thus, the anchor 1110 and therefore the charging plug 117 may be prevented from being pulled inside the charging station 110 by the force of gravity proportional to the weight (mass) of the mobile pulley system 230. The anchor 1110 thus permits securing the cable 116 onto the charging station 110 (onto the plug holder 1115) and immobilizing the cable 116 and the plug 117 between the charging sessions.

The anchor 1110 may have at least one anchor magnet 1122, illustrated in FIG. 11A, that can cooperate (interact) with another magnet 1125 (also referred to herein as a “receiver magnet 1125” or a “magnet detector 1125” or an “anchor detector 1125”) when the anchor 1110 is placed within the plug holder 1115 after the EV 112 has been charged. The magnet detector 1125 may be located on the back of the plug holder 1115, on the back of the anchor groove 1120, as illustrated in FIG. 11D.

The interaction of the anchor magnet 1122 with the receiver magnet 1125 may provide (lead to generation of) an indication to the charging system 100 that the charging plug 117 has been put to rest to the station 110. Alternatively, or in addition, the interaction of the anchor magnet 1122 with the receiver magnet 1125, when the charging plug 117 is taken out of the anchor groove 1120, may be detected and provide an indication to the charging system 100 that the charging plug 117 has been taken (removed from the plug holder 1115) by the user. For example, such an indication may trigger various operations performed by the charging system 100 (for example, related to financial operations) and/or charging station 110 itself. For example, a lock described herein below may be released or locked based on whether the anchor 1110 is located in the anchor groove 1120 or not.

In at least one embodiment, the anchor 1110 may have an anchor body having a tunnel 1133 (as illustrated in FIG. 11A) therein configured to receive a portion of the cable 116 therein. The diameter of the tunnel 1133 may be changed (modified) due to a slit 1130 (FIG. 11B) in the body of the anchor 1110. The slit 1130 defines two edges of the anchor 1110 that permit the anchor 1110 to be clamped onto the cable 116 and grip the cable 116 firmly (immovably) when the distance between the two edges is reduced when the anchor 1110 is fit into the anchor groove 1120 with the cable 116 sitting in the tunnel 1133. For example, the anchor 1110 may be made of a plastic. For example, the anchor 1110 may be made of resin. For example, the anchor 1110 may be made of molded polyurethane (such as, for example, Duro 95A). The material of the anchor 1110 may be at least partially flexible. For example, mixed materials or a combination of materials may be used to produce the anchor 1110.

To place the anchor 1110, with the cable 116 therein, into the anchor groove 1120, the anchor 1110 follows the arrow 1141 to place the anchor 1110 within the cable groove 1117 from the plug groove 1119 and then the anchor 1110 is moved up the anchor groove 1120 to be positioned into the anchor groove 1120 until the anchor abuts and is immobilized by a step positioned between the cable groove 1117 and the anchor groove 1120. Alternative plug holders 1115 are illustrated in FIGS. 11E, 11F.

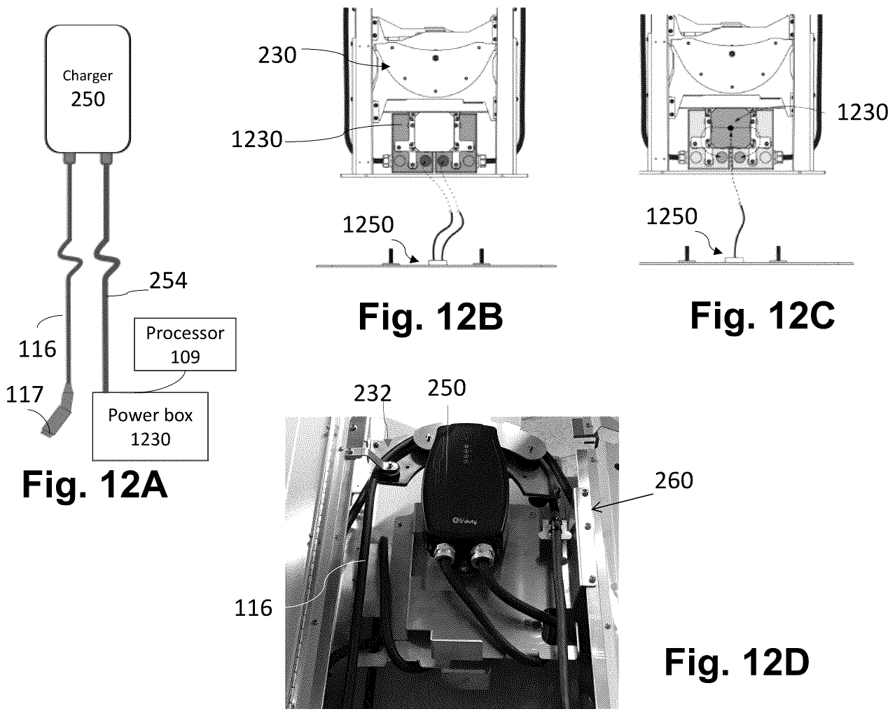

FIG. 12A illustrates schematically a charger 250, a charging cable 116 and a power connector 254 to the power box 1230. The power box 1230 is also connected to the electrical network. FIGS. 12B, 12C illustrate various connections of the power box 1230 to the electrical network 1250. FIG. 12D illustrate partially the charging station 110 showing the charger 250 and the fixed pulley system 232 with the cable 116 located close to the cable outlet 260, in accordance with at least one embodiment of the present disclosure.

Referring now to FIGS. 15A-15C, in at least one embodiment, the charging station 110 further comprises a lock 1260 located at the bottom of the charging station 110. The lock 1260 is configured to lock the mobile pulley system 230 in a locking position after the charging of the EV 122 has been finalized. Thus, in such embodiments, due to the lock 1260, the mobile pulley system 230 and the cable 116 are immobile (immobilized) between different charges. The lock 1260 may be implemented alone or together with the anchor 1110 described above. The cable 116 may not be extended further outside of the charging station 110 than it is at the moment of the lock 1260 being activated. In at least one embodiment, the lock 1260 may be enabled (locked) when the user has placed the charging plug 117 into the plug holder 1115. For example, the anchor magnet 1122 and the receiver magnet 1125 coming into contact may enable the lock 1260. The charging station 110 may have several locks similar to lock 1260 along the trajectory travelled by the cable 116.

In at least one embodiment, when the charging station 110 is not in use, the outside length of the cable 116 is minimized and is determined by the distance between the cable outlet 260 and the anchor 1110. Any additional length of the cable 116 is retracted (rewinded) into the charging station 110 by the weight of the mobile pulley system 230.

In at least one embodiment, the lock 1260 may mechanically lock the mobile pulley system 230 in between the charging sessions.

Referring to FIGS. 15A, 15B, due to the lock 1260 that immobilizes the mobile pulley system 230 between the charges, the plug 117 may thus be also locked in the plug holder 1115 when the charging station 110 is not in use due to the anchor 1110 that attaches the cable 116 to the charging station and the step 1118 in the plug holder 1115, described above. Due to the step 1118, the anchor 1110 may be released from the plug holder 1115 only when an additional length of the cable 116 is available outside of the charging station 110. Referring also to FIG. 11C, the plug 117 may be released from the plug holder 1115 when the anchor 1110 with the cable 116 is moved down and outside of the anchor groove 1120 towards the plug groove 1119 to be released from the anchor groove 1120, which may be only attainable when the cable 116 is pulled out of the cable outlet 260 to have an additional length for the cable 116 and the plug 117 to be moved along the arrow 1142 in FIG. 11C.

When the next user has paid the next charging session, the lock 1260 may be unlocked so that the mobile pulley system 230 may move (travel) up and down freely along the side pillars 222 and therefore permit to extend the cable 116 outside the charging station 110 to a desired length and to release the anchor 1110 from the plug holder 1115.

In at least one embodiment, the lock 1260 may be a mechanical lock activated by an electric signal. FIG. 15C schematically illustrates a non-limiting example of the mechanical lock 1260, in accordance with at least one embodiment of the present disclosure. The mechanical lock 1260 may have, for example, one part attached to the base 210 of the charging station 110 which may be referred to as a lock immovable part 1262 of the charging station 110, and another part of the lock which may be referred to as a lock movable part 1261, that is attached to the mobile pulley system 230. The lock immovable part 1262 may have a series of grooves 1264 or protrusions that may be touched by the lock movable part 1261 when the cable 116 is pushed into the charging station 110 and the mobile pulley system 230 is moved down (pulled down by the weight of the mobile pulley system 230). However, the combination of the lock movable part 1261 and the lock immovable part 1262 may not permit the mobile pulley system 230 to move up without the release of the lock 1260 that may be activated in response to the next charging session being paid.

The braking motor used for the additional mechanical braking system 257 maybe be similarly used to move a latch that would block the mobile pulley system 230. This approach may be made robust by a feedback mechanism that, in the event of failure, aims to unblock the mobile pulley system 230. In at least one embodiment, a solenoid lock may be used for implementing the mechanical lock 1260.

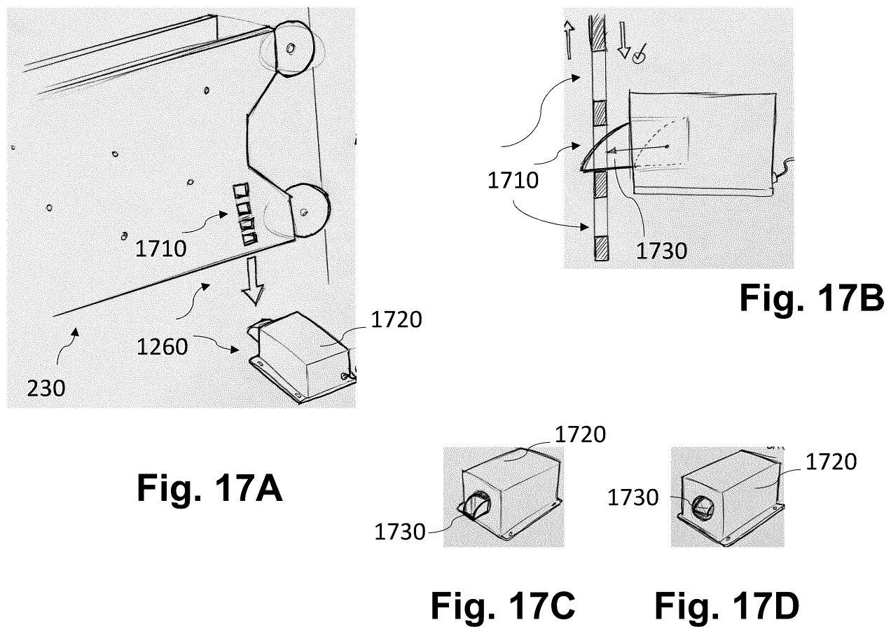

FIGS. 17A-17D illustrate another non-limiting embodiment of the mechanical lock 1260 and the operation of the mechanical lock 1260 (which may also be referred to as a “mechanical pulley lock 1260”) when the mobile pulley system 230 moves. Such mechanical lock 1260 has a series of apertures 1710, for example, in the plates (for example, first mobile pulley plate 505) of the mobile pulley system 230. The mechanical lock 1260 also has a latch housing 1720 which operates a latch 1730. When the power is on, the latch 1730 is out (FIG. 17C) and the mobile pulley system 230 may be locked, when the power in the latch housing 1720 is off, latch 1730 is inside the latch housing 1720 (FIG. 17D), and the mobile pulley system 230 is not retained by the lock 1260. The mechanical lock 1260 allows the mobile pulley system 230 to move down while preventing the mobile pulley system 230 to go up and therefore to release more cable 116 outside of the charging station 110.

The charging station 110 (and/or in some embodiments, the plug holder 1115) may have an LED (or another light source) that may provide visual indication to the user, such as, for example, the variable light signals according to the state of the charging station 110 and the state and position of the charging plug 117. The magnet 1122 located on the anchor 1110 helps to detect whether the plug 117 is located (and fixed) in the plug holder 1115.

The charging station 110 may also have a display screen that is configured to display information to the user, such as, for example, tariffs, etc. The charging station 110 may have a radio-frequency identification (RFID) reader 1150 that may read a user's pay card and may help to charge the user's account. In other words, the RFID reader 1150 may detect that the user's pay card is nearby the reader 1150 and read the information contained therein.

The state of the charger 250 and of the charging station in general may be controlled based on the information received by the RFID reader 1150, actions by the user (for example, whether the plug 117 is in the plug holder 1115 or outside of the plug holder 1115). The information read from the RFID reader 1150 and received from the magnetic reader 1125 from the anchor's magnet 1122 may be transmitted to the charging system 100.

The charging system 100 has a master processor 107 which may be located inside the master charger unit 105. Each charging station 110 may have its local processor 109 connected to the power box 1230 as illustrated in FIG. 12A. The local processor 109 may communicate wirelessly or via a wire connection to the master processor 107. The charging system 100, by master processor 107 and/or local processor 109, may process the data and the indicators received from the receiver magnet 1125 and the RFID reader 1150, and then transmit to the charging station 110, and therefore to the local processor 109, the next steps to execute. For example, the lock 1260 may be unlocked after the payment is received and processed by the charging system 100, the lights of the LED may be changed, etc.

The cable management system for the electric charging station as described herein comprises a braking device that is configured to at least partially immobilize the cable outside of the cable outlet of the charging station. The braking device is configured to apply friction to the cable to brake the movement of the cable in and out of the charging station. The charging station has a cable extension system having a mobile pulley system and a fixed pulley system, each comprising of a plurality of cable wheels located on circumferences along which the cable moves (travels) when the cable is extended out of the charging station by a pulling force applied by the user to the cable and when the cable is pulled into (in other terms, retracted into) the charging station by a force of gravity of the weight of the mobile pulley system which simultaneously displaces towards a lower position.

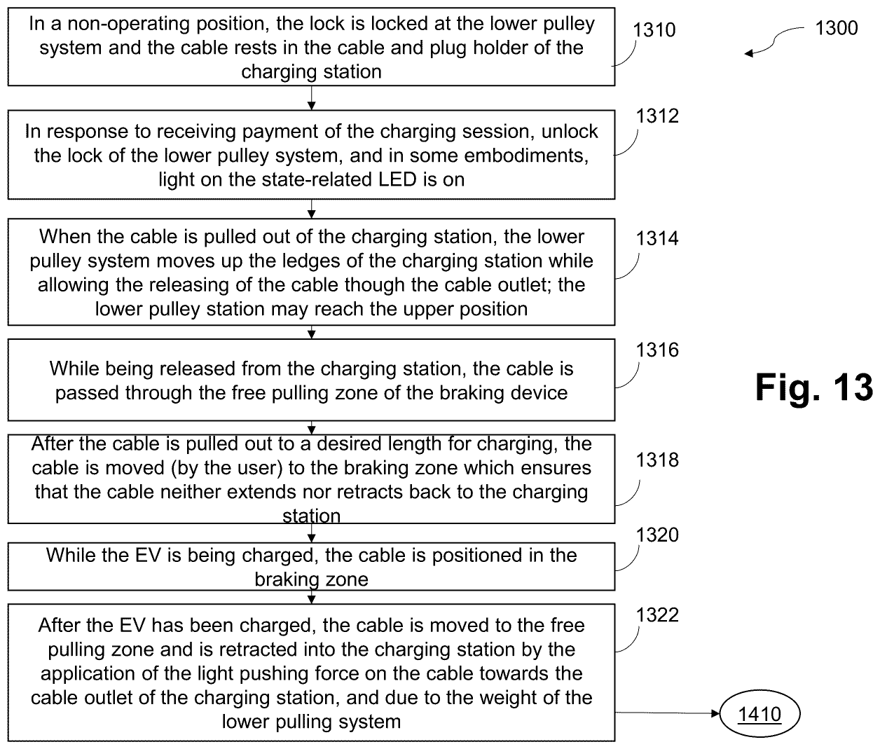

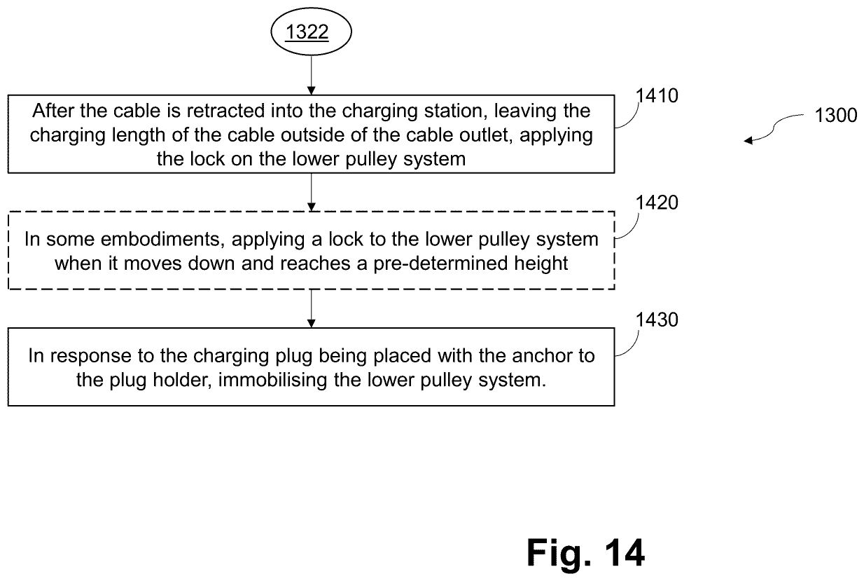

FIGS. 13 and 14 illustrate steps of a method 1300 of cable management of the charging station 110 as described herein, in accordance with various embodiment of the present disclosure. When describing the steps of the method 1300, reference will be also made to FIGS. 1A to 12D and 15A to 15C.

At step 1310, in a non-operation position, the lock 1260 is locked at the mobile pulley system 230 and the cable 116 and the anchor 1110 rest in the plug holder 1115 of the charging station 110. At step 1312, in response to receiving payment of the charging session 110, the lock 1260 of the lower pulley system 230 is unlocked, and in some embodiments, light on the state-related LED (or another light source) is on.

At step 1314, when the cable 116 with the plug 117 is pulled out of the charging station 110, the lower pulley system 230 moves up the ledges of the pillars of the charging station 110 while allowing the releasing of the cable 116 though the cable outlet 260; the lower pulley system 230 may reach the upper position. The upper position of the lower pulley system 230 may be neighboring or abutting the upper fixed pulley system 232.

At step 1316, while being released from the charging station 110, the cable 116 passes through (is passed through) the cable outlet 260 and the free pulling zone of the braking device 270. At step 1318, after the cable 116 is pulled out to a desired length for charging, the cable 116 is moved (by the user) to the braking zone 272 which ensures that the cable 116 neither extends from nor retracts back into the charging station 110.

As described above, an additional mechanical braking system 257 (schematically illustrated in FIG. 3C) may be also added to the braking device 270. The additional mechanical braking system 257 may be activated automatically when the user connects the charging plug 117 into the EV 122.

At step 1320, while the EV 122 is being charged, the cable 116 is positioned in the braking zone 272. At step 1322, after the EV 122 has been charged, the cable 116 is moved (by the user) to the free pulling zone 275 and is retracted into the charging station 110 by the application of a light pushing force on the cable 116 towards the cable outlet 260 of the charging station 110, and due to the weight of the lower pulley system 230.

At step 1410, after the cable 116 is retracted into the charging station 110, leaving a pre-determined locking length of the cable 116 outside of the cable outlet 260, the lock 1260 is applied on the lower pulley system 230 to lock its position. The pre-determined locking length of the cable 116 may be approximately equal to a distance between the cable outlet 260 and the charging plug 117 when the charging plug 117 is positioned into the plug holder 1115, and, in the embodiments having the anchor 1110, when the anchor 1110 is positioned into the anchor groove 1120. At step 1420, in some embodiments, the lock 1260 may engage with the lower pulley system 230 when it moves down and until it reaches a pre-determined height and/or until the cable 116 with the anchor 1110 is positioned into the anchor groove 1120, which may be determined by detecting the magnet 1122 of the anchor 1110 by the magnet detector 1125.

At step 1430, in response to the charging plug 117 with the anchor 1110 being detected in the plug holder 1115, the lower pulley system 230 is immobilized by the lock 1260.

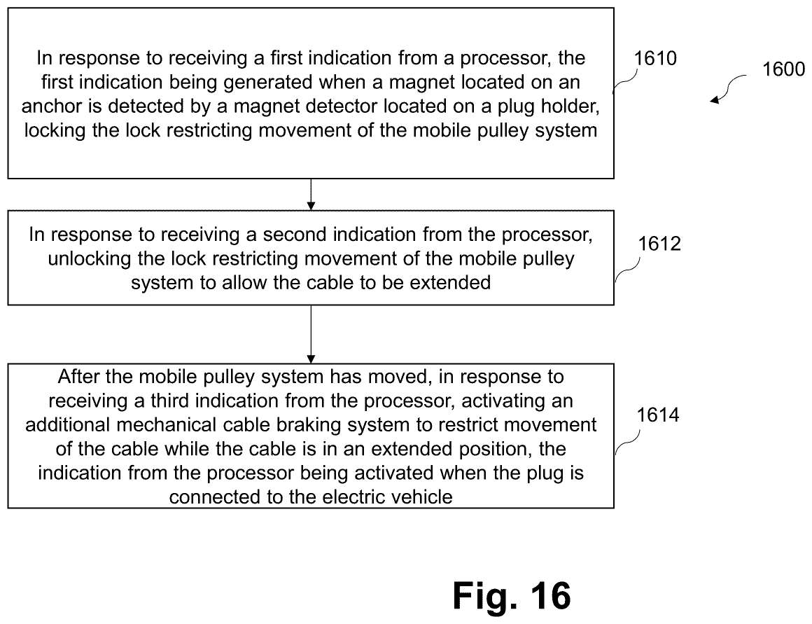

FIG. 16 illustrates another embodiment of the method (referred to herein as method 1600) of cable management of the charging station 110. At step 1610, in response to receiving a first indication from the processor (the master processor 107 or the local processor 109), the first indication being generated when an anchor magnet 1122 located on an anchor is detected by a magnet detector 1125 located on a plug holder 1115, the lock 1260 is locked thus restricting movement of the mobile pulley system 230. At step 1612, in response to receiving a second indication from the processor, the lock 1260, which restricted movement of the mobile pulley system, is unlocked to allow the cable 116 to be extended. At step 1614, after the mobile pulley system 230 has moved up, in response to receiving a third indication from the processor, the additional mechanical braking system 257 is activated to restrict movement of (provide braking effect to) cable 116 while the cable 116 is in an extended position outside of the charging station 110. The indication from the processor may be activated, for example, when the plug 1110 is connected to the EV 122. In some embodiments, in addition to the additional mechanical braking system 257, an upper pulley lock may be activated which is similar to the mechanical lock 1260 (non-limiting examples of which are illustrated in FIGS. 15C and 17A-17D) and which permits restricting movement of the mobile pulley system 230.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A cable management system for an electric charging station for an electric vehicle, the cable management system comprising:
a braking device located at a cable outlet of the electric charging station, the braking device having
a free pulling zone having free pulling bristles and
a braking zone having braking bristles, the braking bristles being stiffer than the free pulling bristles and the braking bristles being configured to at least partially immobilize a charging cable outside of the cable outlet of the electric charging station by applying friction to the charging cable to brake any movement of the cable into the charging station during charging of the electric vehicle, the friction applied to the charging cable by the braking bristles being higher than by the free pulling bristles.

2. The cable management system of claim 1 further comprising a pair of braking blocks having a braking gap therebetween and located in the braking zone of the braking device for immobilization of the charging cable when the charging cable is placed into the braking zone by moving the charging cable out from the free pulling zone.

3. The cable management system of claim 1 wherein the braking bristles are stiffer than the free pulling bristles to be able to hold the cable in place and outweigh a portion of the cable and a plug that extends outside the electric charging station.

4. The cable management system of claim 1 wherein the diameter of the braking bristles is larger than the diameter of the free pulling bristles.

5. The cable management system of claim 1 wherein the free pulling bristles are curled.

6. The cable management system of claim 1 wherein the braking bristles and the free pulling bristles are attached to bristle holders.

7. The cable management system of claim 1 further comprising:
a mobile pulley system and a fixed pulley system, each comprising a plurality of cable wheels located on arcs along which the charging cable moves
when the charging cable is extended out of the charging station by a pulling force applied by a user to the charging cable and
when the charging cable is retracted into the charging station by a force of gravity on a weight object of the mobile pulley system which simultaneously displaces towards a lowered position,
the mobile pulley system being located lower than the fixed pulley system and being configured to travel up and down along ledges of the charging station.

8. The cable management system of claim 7, wherein the mobile pulley system comprises rollers, each roller having a groove configured to receive a portion of one ledge to allow the mobile pulley system to slide up and down the ledges.

9. The cable management system of claim 8, wherein the groove of each roller has a tapered inner surface.

10. The cable management system of claim 1 having an anchor and a plug holder configured to receive the anchor.

11. The cable management system of claim 10 wherein the anchor has a tunnel for receiving a portion of the charging cable therein and a slit which defines two edges of the anchor that permit the anchor to be clamped onto the charging cable and grip the cable immovably when a distance between the two edges is reduced when the anchor is fit into an anchor groove located in the plug holder.

12. The cable management system of claim 1 having a lock configured to lock the mobile pulley system in a locking position.

13. The cable management system of claim 1 further comprising an additional mechanical cable braking system configured to pinch the cable to prevent the cable from retracting back into the charging system.

14. A charging station for an electric vehicle comprising the cable management system of claim 1.

15. A cable management system comprising:
a mobile pulley system and a fixed pulley system, each comprising a plurality of cable wheels located on arcs along which the charging cable moves
when the charging cable is extended out of the charging station by a pulling force applied by a user to the charging cable and
when the charging cable is retracted into the charging station by a force of gravity on a weight object of the mobile pulley system which simultaneously displaces towards a lowered position,
the mobile pulley system being located lower than the fixed pulley system and being configured to travel up and down along ledges of the charging station.

16. The cable management system of claim 15, wherein the mobile pulley system comprises rollers, each roller having a groove configured to receive a portion of one ledge to allow the mobile pulley system to slide up and down the ledges.

17. The cable management system of claim 16, wherein the groove of each roller has a tapered inner surface.

18. The cable management system of claim 15 having an anchor and a complementary plug holder.

19. The cable management system of claim 15 having a lock configured to lock the mobile pulley system to restrict movement of the mobile pulley system.

20. The cable management system of claim 15 further comprising an additional mechanical cable braking system configured to pinch the cable to prevent the cable from retracting back into the charging system.

21. A charging station for an electric vehicle comprising the cable management system of claim 15.

22. A method for managing a cable of a charging station, the method comprising:
in response to receiving a first indication from a processor, the first indication being generated when a magnet located on an anchor is detected by a magnet detector located on a plug holder, locking a lock restricting movement of a mobile pulley system;
in response to receiving a second indication from the processor, unlocking the lock restricting movement of the mobile pulley system to allow the cable to be extended outside of the charging station; and
after the mobile pulley system has moved, in response to receiving a third indication from the processor, activating an additional mechanical cable braking system to restrict movement of the cable while the cable is in an extended position, the indication from the processor being activated in response to the plug being connected to an electric vehicle.

23. A system for managing a cable of a charging station, the system comprising:
a magnet located on an anchor, the anchor being attached to the cable, the magnet configured to be detected by a magnet detector located on a plug holder of the charging station; and
a lock configured:
to restrict movement of a mobile pulley system in response to receiving a first indication that the magnet is detected by a magnet detector located on a plug holder, and
to be unlocked in response to receiving a second indication to allow the cable to be extended from the charging station.

24. The system of claim 23 further comprising an additional mechanical cable braking system configured to restrict movement of the cable while the cable is in an extended position in response to the plug being connected to an electric vehicle.

25. A method for operating an electric charging station for an electric vehicle, the method comprising:
placing a cable in a free pulling zone for displacing freely into the electric charging station, and
restricting movement of a charging cable when the charging cable is placed into a braking zone of a braking device located at a cable outlet of the electric charging station, a braking friction applied to the charging cable in the braking zone being higher than a free-moving friction applied to the charging cable in the free pulling zone.
